(19) United States
(12) Patent Application Publication
(10) Pub. No.: US 2004/0044579 A1
(43) Pub. Date: Mar. 4, 2004

(54) System and method for facilitating a food transaction

(76) Inventors: Neil Matthew Leutze, Midlothian, VA (US); Scott Campbell Pontius, Midlothian, VA (US)

Correspondence Address: NEIL MATTHEW LEUTZE, 13600 TRILITHON ROAD, MIDLOTHIAN, VA, 23113, US

(21) Appl. No.: 10/356,747

(22) Filed: Feb. 3, 2003

Related U.S. Application Data
(60) Provisional application No. 60/407,754, filed on Sep. 3, 2002.

(51) Int. Cl. G06F 17/60

(52) U.S. Cl. 705/15

(57) ABSTRACT

A method for facilitating food transactions is disclosed. The method first includes accepting by a central management system, customer login input from a customer system, verifying the customer login input, presenting food transaction search options to the customer system, and accepting customer search input from the customer system, the customer search input including a vendor limiting selection. The method further includes presenting at least one vendor option including a plurality of menu options to the customer system, the at least one vendor option associated with the vendor limiting selection and a vendor system. The method further includes accepting a customer food order selected from the menu options, and verifying customer payment funds in an associated customer account. Lastly, the method includes transmitting the customer order to the vendor system, and debiting the customer account for payment of the customer order.

### BACKGROUND OF INVENTION

The invention relates generally to systems and methods for facilitating a food transaction.

As the world becomes a busier place, many people are taking less time to cook meals at home, which leads to endless eating out at restaurants. People are working longer hours, leaving less time for grocery shopping (if that is even convenient in some locals), and often cannot fit the time in their schedule to cook a meal even if they wanted to do so. Other people simply may not have the necessary facilities to cook food out of their living abode. This problem affects business travelers, in large part, because most travel accommodations do not provide cooking facilities. College students are also plagued by similar problems. Many university living arrangements do not provide cooking facilities for use by the general student population, and many students are regulated to the old-fashioned dining halls on university maintained student dining plans.

There is a need for an accessible service that makes ordering food from restaurants and other dining establishments easy, by providing searchable dining options (regardless of the customer's location), online ordering, and online account management. With the growing popularity of and access to the Internet, through conventional home computers and available forms of wireless communication, i.e., PDAs, mobile phones with Internet access, for example, a service offered through customer accessible networks may provide one potential avenue of satisfying this need.

The invention provides systems and methods, for facilitating food transactions, that overcomes the disadvantages of known systems and methods while offering features not present in known systems and methods.

### SUMMARY OF INVENTION

### BRIEF SUMMARY OF THE INVENTION

In accordance with one embodiment of the invention, a method for facilitating food transactions is disclosed. The method first includes accepting by a central management system, customer login input from a customer system, verifying the customer login input, presenting food transaction search options to the customer system, and accepting customer search input from the customer system, the customer search input including a vendor limiting selection. The method further includes presenting at least one vendor option including a plurality of menu options to the customer system, the at least one vendor option associated with the vendor limiting selection and a vendor system. The method further includes accepting a customer food order selected from the menu options, and verifying customer payment funds in an associated customer account. Lastly, the method includes transmitting the customer order to the vendor system, and debiting the customer account for payment of the customer order, for example.

Also, a system for facilitating food transactions is disclosed in accordance with yet another embodiment of the invention. The system comprises a central management system, wherein the central management system accepts customer login input from a customer system. The central management system verifies the customer login input and presents food transaction search options to the customer system. The central management system accepts customer search input from the customer system, the customer search input including a vendor limiting selection. The central management system presents at least one vendor option including a plurality of menu options to the customer system, the at least one vendor option associated with the vendor limiting selection and a vendor system. The central management system accepts a customer food order selected from the menu options, and verifies customer payment funds in an associated customer account. Lastly, the central management system transmits the customer order to the vendor system, and debits the customer account for payment of the customer order, for example.

### BRIEF DESCRIPTION OF DRAWINGS

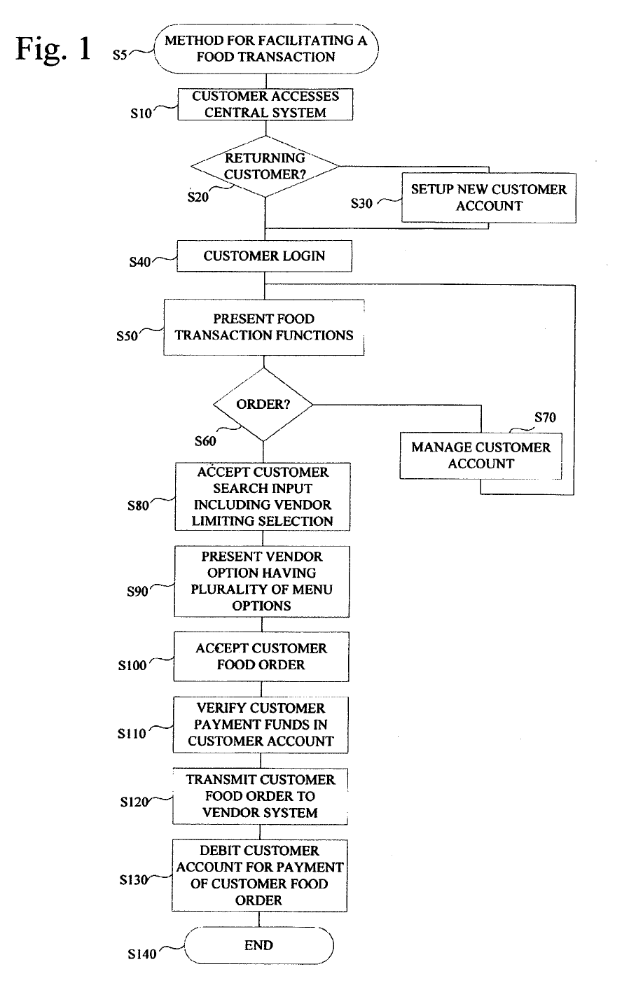

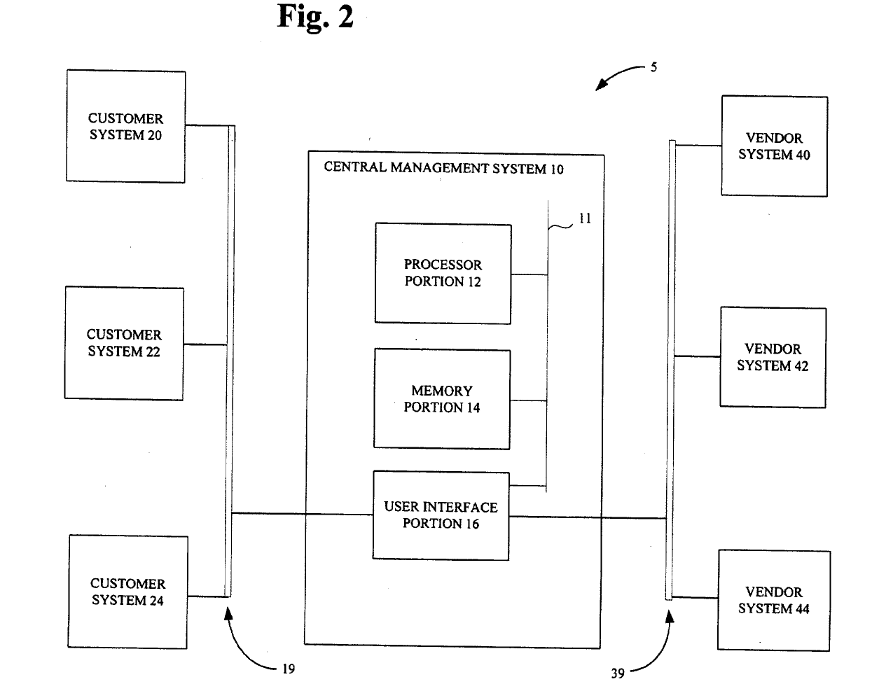

The present invention can be more fully understood by reading the following detailed description together with the accompanying drawings, in which like reference indicators are used to designate like elements, and in which: FIG. 1 is a flowchart showing a method for facilitating a food transaction in accordance with one embodiment of the invention; and FIG. 2 is a block diagram showing an illustrative food transaction system in accordance with one embodiment of the invention.

### DETAILED DESCRIPTION

### DETAILED DESCRIPTION OF THE INVENTION

This application claims the priority of U.S. patent application Ser. No. 60/407,754, System and Method for Facilitating a Food Transaction, filed on Sep. 3, 2002. Hereinafter, various embodiments of the invention will be described. As used herein, any term in the singular may be interpreted to be in the plural, and alternatively, any term in the plural may be interpreted to be in the singular.

The systems and methods, as disclosed herein, are directed to the problems stated above, as well as other problems that are present in conventional techniques. Any foregoing description of various products, methods, or apparatus and their attendant disadvantages described in the Background of the Invention is in no way intended to limit the scope of the invention, or to imply that invention does not include some or all of the various elements of know products, methods and apparatus in one form or another. Indeed, various embodiments of the invention may be capable of overcoming some of the disadvantages noted in the Background of the Invention, while still retaining some or all of the various elements of known products, methods, and apparatus in one form or another.

The invention provides a combination of technologies that allow a customer to access a system through which the customer can commence a food transaction, arrange for pickup or delivery of the customer food order, pay for the transaction through the use of a pre-paid account managed by the system, from anywhere where network access is possible. The food transaction system acts as an intermediary between the customers and the various food vendors, i.e., restaurants, for example. The system maintains information on customer accounts as well as the dining options available at participating vendors, allows customers to order from those vendors, and places the order for the customer upon verification of the customers payment funds. In this respect, the customer is provided with a convenient forum for placing food orders and maintaining an account that preferably does not require the customer to carry conventional credit cards, checks or cash. The vendors are provided with more customers resulting from the ease of access to their food services.

Consider, for example, one illustrative embodiment of the invention as described in the following scenario. A college student is leaving for school. Instead of the school's conventional meal plan, the college student desires to sign up for a service that allows him to setup an account that allows him to buy food from restaurants in the area. The student goes online and visits a website associated with the system of the invention. The student provides required customer information, as well as information on planned course of payment (i.e., check, over the telephone deposit, or credit card charge). Once the customer information is verified, the website allows the student to search for dining options by restaurant name, genre, location (geographical or identity, i.e., college campus), or even delivery option. The student may establish certain system defaults such that when the student searches by name or genre, the website presents those vendors fitting the selection and also located within a certain distance of the student's address provided in the account setup.

When the student selects a vendor to order from, the website presents the vendors menu, and allows the student to drop and drag food selections onto a graphical order form. Once finalized, the system requests confirmation from the student, confirms the necessary funds are in the student's account as maintained in the customer account database, and transmits the order directly to the vendor to be filled. The order is then delivered to the student, or picked up by the student, depending on the option selected. By maintaining the student customer's account on the central management system, the student does not need to worry about carrying money, and parents or friends can deposit money directly into the student's account if it is running low.

In at least one implementation of the invention, the central management system manages at least one relational database of information while also allowing access, by the various users (i.e., administrators, vendors, and customers) of the central management system, to the various applications, features and user interfaces of the invention. A relational database system allows information contained in different tables to be accessed and shared, while also providing the additional advantage that changes to data contained in one table of a relational database affects the same data in any other table sharing the same data. For example, a table is a collection of several data records with similar data information fields. Data records represent a collection of data that is organized into fields. These fields may also be formatted to receive data of varying types. Accordingly, the database user can view data records in a user interface, input or edit the data contained in the various fields, or issue a database query that retrieves and reports information from multiple tables.

The central management system may manage various databases (with fields) including a restaurant database (name, address, phone number, hours of operation, menu, brief description, genre, delivery options, contact person, payment schedule, system or receiver number, delivery zip codes or delivery location(s) or school, delivery number), a transaction database (restaurant name, customer number, transaction date, transaction total, transaction order, remaining balance, order number), a customer database (customer number, name, address, phone number, e-mail, account number, pin number, user name, password, university and/or class (if applicable), low balance, account balance, loyalty points), a menu database (restaurant, dish, description, sides, price, add-ons), for example. Illustratively, when a customer accesses the central management system, previously stored information associated with the particular customer, such as account balances or transaction history, which may be presented on the user interface. Thus, customer information and transaction history can be tracked in the customer database. The restaurant database is a compilation of the participating vendors and their associated information. The transaction database may be used for historical and accounting purposes.

What is claimed is:

1. A method for facilitating food transactions comprising the steps of:
accepting by a central management system, customer login input from a customer system;
verifying the customer login input;
presenting food transaction search options to the customer system;
accepting customer search input from the customer system, the customer search input including a vendor limiting selection;
presenting at least one vendor option including a plurality of menu options to the customer system, the at least one vendor option associated with the vendor limiting selection and a vendor system;
accepting a customer food order selected from the menu options;
verifying customer payment funds in an associated customer account;
transmitting the customer order to the vendor system in real time; and
debiting the customer account for payment of the customer order.

2. A system for facilitating a food transaction comprising:
a central management system, the central management system:
accepting customer login input from a customer system;
verifying the customer login input;
presenting food transaction search options to the customer system;
accepting customer search input from the customer system, the customer search input including a vendor limiting selection;
presenting at least one vendor option including a plurality of menu options to the customer system, the at least one vendor option associated with the vendor limiting selection and a vendor system;
accepting a customer food order selected from the menu options;
verifying customer payment funds in an associated customer account;
transmitting the customer order to the vendor system in real time; and
debiting the customer account for payment of the customer order and presents food transaction search options to the customer system.
